(19) United States
(12) Patent Application Publication
(10) Pub. No.: US 2015/0316259 A1
(43) Pub. Date: Nov. 5, 2015

(54) APPARATUS FOR GAS SCRUBBING

(71) Applicant: THYSSENKRUPP UHDE GMBH, Dortmund (DE)

(72) Inventors: Jan SCHÖNEBERGER, Dortmund (DE); Holger THIELERT, Dortmund (DE)

(21) Appl. No.: 14/646,220

(22) PCT Filed: Oct. 25, 2013
(86) PCT No.: PCT/EP2013/072413

§ 371 Date: May 20, 2015

(30) Foreign Application Priority Data
Nov. 20, 2012 (DE) 102012111185.5

(51) Int. Cl. F23J 15/04; B01D 53/18; B01D 53/14

(52) U.S. Cl. CPC F23J 15/04; B01D 53/1475; B01D 53/185

(57) ABSTRACT

The invention relates to an apparatus for gas scrubbing, in particular for removing CO₂ from flue gas by means of amine scrubbing. The apparatus comprises a cooling stage for directly cooling and for pre-scrubbing a gas flow entering the apparatus by means of a liquid fed to the cooling stage, an absorption stage for removing at least one gas component from the gas flow by means of a scrubbing liquid fed to the absorption stage, and a post-scrubber for depleting at least one volatile component of the scrubbing liquid from the cleaned gas flow. According to the invention, the cooling stage, the absorption stage, and the post-scrubber are arranged one above the other and connected to form a washing tower.

### FIELD

The present disclosure relates to an apparatus for gas scrubbing, in particular for separating CO₂ from flue gas by means of amine scrubbing.

### BACKGROUND

It is known to connect, downstream of a post-scrubber, an absorber for removing a gas component from a gas flow, in order to deplete from the cleaned gas flow a volatile component of the scrubbing liquid which has transitioned into the gas flow. In the case of amine scrubbing, the post-scrubbing serves for amine recovery. The post-scrubber can be arranged as a column section at the head of the absorber. Often connected upstream of the apparatus is a flue gas cooler in which the gas flow to be cleaned is cooled by being acted on by a liquid. If a suitable liquid is used, direct cooling can be bound up with pre-scrubbing of the gas flow. Within the context of the known measures, the flue gas cooler is connected as a separate apparatus upstream of the absorber, and is connected to the absorber via a pipe. A fan for urging the gas flow can be arranged between the flue gas cooler and the absorber, or downstream of the absorber.

In existing gas cleaning plants whose gas cleaning capacity is to be increased by means of a further or more powerful apparatus for gas scrubbing, there is often not sufficient space for installing a further flue gas cooler and the associated piping. The separate flue gas cooler, and the associated piping, also form a substantial portion of the investment costs of the apparatus.

### BRIEF DESCRIPTION OF THE DRAWINGS

In the following, the invention will be explained with reference to a drawing representing merely an exemplary embodiment. In the figures:

FIG. 1 shows an apparatus for gas scrubbing,

FIGS. 2 and 3 show further embodiment variants of the gas scrubber.

### DETAILED DESCRIPTION

Against this background, the invention is based on the object of providing an apparatus for gas scrubbing which is characterized by small space requirements and low investment costs. In particular, the apparatus should also be suitable for amine scrubbing of the gas to be cleaned.

An apparatus for gas scrubbing as claimed in claim 1 forms the subject matter of the invention and represents the solution to this object.

According to the invention, the apparatus comprises a cooling stage for directly cooling and for pre-scrubbing a gas flow entering the apparatus by means of a liquid fed to the cooling stage, an absorption stage for removing at least one gas component from the gas flow by means of a scrubbing liquid fed to the absorption stage, and a post-scrubber for depleting at least one volatile component of the scrubbing liquid from the cleaned gas flow, wherein the cooling stage, the absorption stage and the post-scrubber are arranged one above the other and connected to form a scrubbing tower. By virtue of the integration, according to the invention, of all the scrubbing stages into one scrubbing tower, the apparatus according to the invention requires a small installation footprint, which is essentially determined by the base area of the cooling stage. The pipe system for supplying the gas flow can be substantially simplified. This has an advantageous effect on investment costs and also on the pressure loss in the gas.

The absorption stage preferably has column inserts for increasing the transfer surface for a material transfer between the gas flow and the scrubbing liquid. Random packings, structured packings and transfer trays are suitable as column inserts.

According to one preferred embodiment of the invention, a separation tray for discharging the scrubbing liquid is provided between the absorption stage and the cooling stage, wherein the separation tray has openings for the gas flow to pass through. The separation tray can for example be designed as a bubble-cap tray or a valve tray. The cooling stage can use a different liquid to the absorption stage. Of course, there is however also the possibility of using the same scrubbing liquid in the cooling stage for directly cooling and pre-scrubbing the gas flow and in the absorption stage for removing the noxious gas component, and to apply different partial flows in the cooling stage and the absorption stage.

In particular, the cooling stage can be designed as a spray apparatus having a multiplicity of spray nozzles and a liquid sump with an outlet for discharging the liquid.

One variant embodiment of the invention provides that the cooling stage has a gas inlet with at least one jet pump, wherein the liquid for the cooling stage can be fed to the jet pump as motive medium, and the jet pump urges the gas flow. The liquid used for directly cooling the incoming gas flow generates a pressure drop in the gas inlet of the cooling stage which draws the gas flow. The jet pump can replace a fan for urging the gas flow or support the urging of the gas by means of a fan. The jet pump is expediently arranged in an upper section of the cooling stage, wherein the flow direction of a gas/liquid mixture leaving the jet pump is oriented vertically or diagonally downward into the container space of the cooling stage. The jet pump can in particular be designed as a venturi scrubber which, by means of the motive medium, not only draws the gas flow to be cleaned but also effectively cools the latter.

According to one further configuration of the apparatus according to the invention, a fan for urging the gas flow is arranged at the head of the scrubbing tower. Arranging the fan at the head of the scrubbing tower makes it possible for a connection piping for discharging the cleaned gas to be flexibly adapted to the local conditions and, in many cases, also simplified. It is also thus possible to further reduce the space requirements of the apparatus.

The post-scrubber can be configured for a lower liquid throughput than the absorption stage. The flow cross section of the post-scrubber, through which gas flows, is smaller than the cross section required for the absorption stage. A section of the scrubbing tower comprising the post-scrubber, and the absorption stage, can be directly connected to one another on the gas side. According to one preferred embodiment of the invention, the liquid from the post-scrubber can be fed directly to the absorption stage without being discharged from the scrubbing tower.

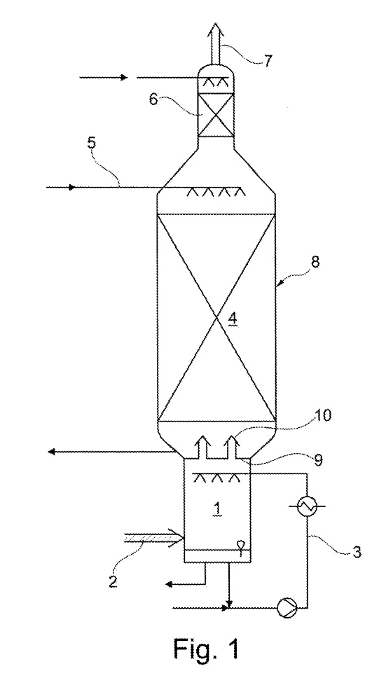

The gas scrubbing apparatus represented in FIG. 1 is used for example for removing CO₂ from flue gas. The apparatus comprises a cooling stage 1 for directly cooling and for pre-scrubbing a gas flow 2 entering the apparatus by means of a liquid 3 fed to the cooling stage 1, an absorption stage 4 for removing at least one gas component from the gas flow by means of a scrubbing liquid 5 fed to the absorption stage, and a post-scrubber 6 for depleting at least one volatile component of the scrubbing liquid from the cleaned gas flow 7. The cooling stage 1, the absorption stage 4 and the post-scrubber 6 are arranged one above the other and connected to form a scrubbing tower 8.

The absorption stage 4 preferably comprises column inserts for increasing the transfer surface for a material transfer between the gas flow 2 and the scrubbing liquid 5, wherein the column inserts can consist of random packings, structured packings or transfer trays. A separation tray 9 for discharging the scrubbing liquid is provided between the absorption stage 4 and the cooling stage 1. The separation tray 9 has openings 10 for the gas flow to pass through and can for example take the form of a bubble-cap tray or a valve tray. By virtue of the separation tray 9, the absorption stage 4 and the cooling stage 1 may be assigned different liquid circuits. However, the cooling stage 1 and the absorption stage 4 may also be operated with the same scrubbing liquid.

The post-scrubber 6 is configured for a lower liquid throughput than the absorption stage 4 and consists of a column section which has a smaller flow cross section than the absorption stage 4. In the post-scrubber 6, too, there may also be provided flow inserts for improving the material transfer between the gas phase and the liquid phase. The liquid from the post-scrubber 6 can be fed directly to the absorption stage 4 without being discharged from the scrubbing tower 8. It is however also within the scope of the invention to provide, between the post-scrubber 6 and the absorption stage 4, a gas-permeable separation tray for discharging the liquid leaving the post-scrubber 6, in order to be able to operate the post-scrubber 6 and the absorption stage 4 with separate liquid circuits.

In the exemplary embodiment of FIG. 1, the cooling stage 1 of the scrubbing tower 8 is designed as a spray apparatus having a multiplicity of spray nozzles and a liquid sump with an outlet for discharging the liquid. The gas to be cleaned flows through the cooling stage 1 counter to the flow of the liquid fed through the spray nozzles. The cooling stage can also contain structured packings, random packings and the like.

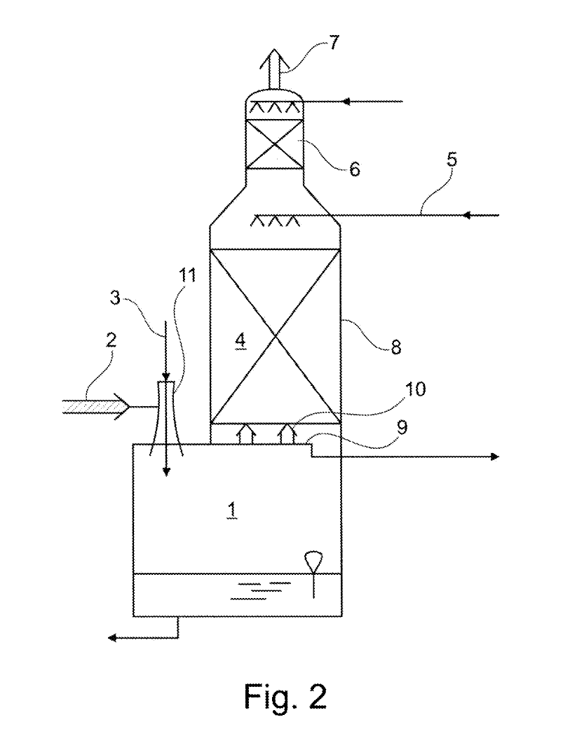

In the exemplary embodiment of FIG. 2, the cooling stage 1 has a gas inlet with at least one jet pump 11, wherein the liquid 3 for the cooling stage 1 can be fed to the jet pump as motive medium. The jet pump 11 brings about a pressure drop in the gas inlet and urges the gas flow. The jet pump 11 is arranged at an upper section of the cooling stage 1 such that the flow direction of a gas/liquid mixture leaving the jet pump is oriented vertically or diagonally downward into the container space of the cooling stage 1. The jet pump 11 can in particular be designed as a venturi nozzle. By virtue of the intensive mixing of the gas 2 and the liquid 3, the venturi nozzle brings about a good cooling of the gas flow in combination with a pre-scrubbing.

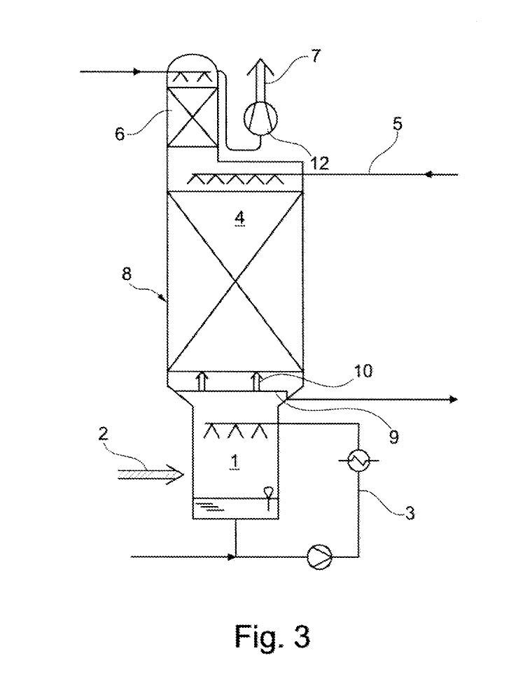

In the exemplary embodiment of FIG. 3, a fan 12 for urging the gas flow 7 is arranged at the head of the scrubbing tower 8. By virtue of this arrangement of the fan 12 at the head of the scrubbing tower 8, a connection piping for discharging the cleaned gas flow 7 can be flexibly adapted to the local conditions and, in many cases, simplified.

The apparatus represented in the figures can be used for gas scrubbing and in particular for amine scrubbing of CO₂-containing gases. In the case of amine scrubbing, an amine solution is used as scrubbing liquid.

1-10. (canceled)

11. An apparatus for gas scrubbing, in particular for removing CO₂ from flue gas by means of amine scrubbing, with the apparatus comprising:
a cooling stage for directly cooling and for pre-scrubbing a gas flow entering the apparatus by means of a liquid fed to the cooling stage;
an absorption stage for removing at least one gas component from the gas flow by means of a scrubbing liquid fed to the absorption stage; and
a post-scrubber for depleting at least one volatile component of the scrubbing liquid from the cleaned gas flow,
wherein the cooling stage, the absorption stage and the post-scrubber are arranged one above the other and connected to form a scrubbing tower.

12. The apparatus of claim 11, wherein the absorption stage has column inserts for increasing a transfer surface for a material transfer between the gas flow and the scrubbing liquid.

13. The apparatus of claim 11 further comprising: a separation tray for discharging the scrubbing liquid provided between the absorption stage and the cooling stage.

14. The apparatus of claim 13 wherein the separation tray has openings for the gas flow to pass through.

15. The apparatus of claim 13 wherein the cooling stage is designed as a spray apparatus having a multiplicity of spray nozzles and a liquid sump with an outlet for discharging the liquid.

16. The apparatus of claim 11 wherein the cooling stage has a gas inlet with at least one jet pump.

17. The apparatus of claim 16 wherein the liquid for the cooling stage is fed to the jet pump as motive medium, and the jet pump urges the gas flow.

18. The apparatus as claimed in claim 17, wherein the jet pump is arranged in an upper section of the cooling stage.

19. The apparatus of claim 18 wherein a gas/liquid mixture leaves the jet pump in a flow direction which is oriented vertically downward.

20. The apparatus of claim 18 wherein a gas/liquid mixture leaves the jet pump in a flow direction which is oriented diagonally downward.

21. The apparatus of claim 18, wherein the jet pump is designed as a venturi scrubber.

22. The apparatus of claim 11 further comprising:
a fan for urging the gas flow arranged at the head of the scrubbing tower.

23. The apparatus of claim 11 wherein the post-scrubber is configured for a lower liquid throughput than the absorption stage.

24. The apparatus of claim 11 wherein the liquid from the post-scrubber is fed directly to the absorption stage without being discharged from the scrubbing tower.
